(19) United States
(12) Patent Application Publication
(10) Pub. No.: US 2008/0144572 A1
(43) Pub. Date: Jun. 19, 2008

(54) Method and Apparatus for Achieving Frequency Diversity in Scheduled Packet Data Transmissions

(76) Inventor: Mahesh A. Makhijani, San Diego, CA (US)

Correspondence Address: COATS & BENNETT/ERICSSON WIRELESS COMM''S., INC., 1400 CRESCENT GREEN, SUITE 300, CARY, NC, 27518, US

(21) Appl. No.: 11/611,402

(22) Filed: Dec. 15, 2006

(51) Int. Cl. H04Q 7/00

(52) U.S. Cl. 370/330

(57) ABSTRACT

Carrier frequency selection is enabled in transmitting packet data between a radio transceiver and a mobile station and in a wireless communication network with shared packet data service. The packet data service permits transmission of packet data along a packet data link comprising a plurality of shared packet data channels, such as that provided by the N×EV-DO protocol. Each channel is characterized by a unique carrier frequency. Packet data may be divided and transmitted among the plurality of channels. Packet data may be transmitted along a first of the plurality of channels. Upon receiving a negative acknowledgement indicative of an erroneous packet transmission in accordance with known error control schemes such as HARQ, retransmission data may be transmitted along a second of the plurality of channels. As multiple carrier frequencies are used to transmit packet data and retransmission data, frequency diversity is added to time diversity inherent in retransmission protocols.

### BACKGROUND OF THE INVENTION

The present invention generally relates to wireless communication networks, and particularly relates to facilitating the use of multiple carrier frequencies for packet and sub-packet data transmissions on shared, high-rate packet data links.

Wireless communication networks based on the IS-2000 family of standards make use of a shared packet data link to provide forward link packet data services at high rates to a plurality of mobile stations. For example, protocols such as the 1×EV-DO standard and other contemporary networks use time-shared, high-rate packet data channels to transmit packet data to a plurality of scheduled users. Generally, the packet data link is allocated to the individual mobile stations by a scheduler that allows the mobile stations to receive packet data on the packet data link. Thus, the packet data link in each sector carries data for each of the mobile stations being served by that sector. Current proposals such as the N×EV-DO standard provide greater capacity for improved performance via multiple, shared packet data channels, each operated at a different carrier frequency.

With respect to any one assigned carrier frequency, a data error control scheme may be employed whereby a receiver acknowledges the successful receipt of packet data over the channel. Different error control schemes are known, including for example, basic automatic repeat request (ARQ) and hybrid ARQ (HARQ) schemes. These different schemes may be classified further based upon the ability for the receiver and/or transmitter to store transmitted data packets. In one example, the receiver and transmitter each include a buffer. The transmitter includes a buffer to store data packets for possible retransmission. The receiver includes a buffer to properly sequence received packets. HARQ schemes attempt to improve throughput by combining ARQ protocols with error correction codes. At least three different types of HARQ schemes are known. In one type, erroneous packets are discarded and a retransmission request is sent to the transmitter. In response to the retransmission request, an entire “replacement” packet is retransmitted. In another type of HARQ scheme, retransmitted packets consist primarily of additional parity bits that can be used by the receiver to reconstruct the erroneous packet. In a third type of HARQ scheme, individual packets are self-contained in that they include an associated coding sequence that may be used by the receiver to decode the packet for combination with other received packets. Synchronous and asynchronous HARQ schemes are also known. These ARQ and HARQ schemes offer time diversity to improve performance since erroneously received data may be delivered as part of a retransmission. One characteristic of conventional high-rate service on shared channels is that each mobile station receives packet data on a single carrier. Furthermore, retransmissions are delivered using the same channel and carrier frequency. In addition, if a given carrier frequency includes significant interference, it may be likely that the interference remains present when the retransmissions occur.

### SUMMARY OF THE INVENTION

Embodiments disclosed herein provide a method and apparatus for selecting carrier frequencies for packet and sub-packet data transmissions over one or more high rate packet data channels. Methods and devices are provided to enable frequency diversity in transmitting packet data to a mobile station in a wireless communication network. In one implementation, scheduled packet data is transmitted to the mobile station via a first shared packet data channel operating at a first carrier frequency, which in one or more embodiments is the carrier frequency offering the best signal quality or best service conditions to the mobile station. The mobile station may transmit a negative acknowledgement indicative of erroneous packet data reception. In response to the negative acknowledgement, scheduled retransmission data may be transmitted to the mobile station via a second shared packet data channel operating at a second carrier frequency different from the first carrier frequency. The first and second shared packet data channels may conform to an N×EV-DO wireless communications protocol. Further, the negative acknowledgement and retransmission data may conform to an HARQ error control scheme. In general, the teachings herein are applicable to any multi-carrier communication system that uses an HARQ error control scheme, such as OFDMA/OFDM (Orthogonal Frequency Division Multiple Access/Orthogonal Frequency Division Multiplexing) communication networks, which provide multiple carrier frequencies (e.g., multiple subsets of available sub-carrier frequencies) for the transmission and retransmission of data.

A complementary mobile station may receive scheduled packet data via the first shared packet data channel operating at the first carrier frequency. Upon detecting an erroneously received packet from the first shared packet data channel, the mobile station may transmit a negative acknowledgement in response to detecting the erroneously received packet. Then, the mobile station may receive scheduled retransmission data corresponding to the erroneously received packet via the second shared packet data channel operating at the second carrier frequency.

In one implementation, packet data may be transmitted to a mobile station in a wireless communication network with packet data service by initially transmitting scheduled first packet data to the mobile station via a first shared packet data channel operating at a first carrier frequency. While transmitting the first packet data, if transmission slots are available via a second shared packet data channel operating at a second carrier frequency different from the first carrier frequency, scheduled second packet data may be transmitted to the mobile station via the second shared packet data channel. The first and second packet data may comprise diverse transmissions of the same data. Alternatively, the first and second packet data may comprise altogether different data transmissions. Alternatively still, the second packet data may comprise retransmission data corresponding to erroneously received packets of the first packet data.

Of course, other channel selection and processing algorithms may be adopted as needed or desired, and it should be understood that the present invention is not limited to the above features and advantages. Indeed, those skilled in the art will recognize additional features and advantages upon reading the following detailed discussion, and upon viewing the accompanying figures.

### BRIEF DESCRIPTION OF THE DRAWINGS

FIG. 1 is a diagram of an exemplary wireless communication network according to one or more embodiments of the present invention;

FIG. 2 is a diagram of a packet data link between a mobile station and a base transceiver station according to one or more embodiments of the present invention;

FIG. 3 is a diagram of transmitter and receiver circuit details for an exemplary packet data link according to one or more embodiments of the present invention;

FIG. 4 is a diagram illustrating a division of packet data and re-transmission data among distinct carriers forming a packet data link according to one or more embodiments of the present invention;

FIG. 5 is a diagram illustrating a division of packet data among distinct carriers forming a packet data link according to one or more embodiments of the present invention;

FIG. 6 is a diagram of exemplary network processing logic to implement the division of packet data and re-transmission data among distinct channels forming a packet data link according to one or more embodiments of the present invention;

FIG. 7 is a diagram of exemplary network processing logic to implement the reception of packet data and re-transmission data from distinct channels forming a packet data link according to one or more embodiments of the present invention;

FIG. 8 is a diagram of exemplary network processing logic to implement the packet data division among distinct carriers forming a packet data link according to one or more embodiments of the present invention;

FIG. 9 is a diagram of exemplary network processing logic to receive and reconstruct packet data received from distinct carriers forming a packet data link according to one or more embodiments of the present invention;

FIG. 10 is a diagram of exemplary network processing logic to determine an optimal carrier among distinct carriers forming a packet data link according to one or more embodiments of the present invention; and

FIG. 11 is a diagram of exemplary network processing logic to detect whether transmission slots are available for transmitting scheduled packet data on a plurality of shared packet data channels according to one or more embodiments of the present invention.

### DETAILED DESCRIPTION OF THE INVENTION

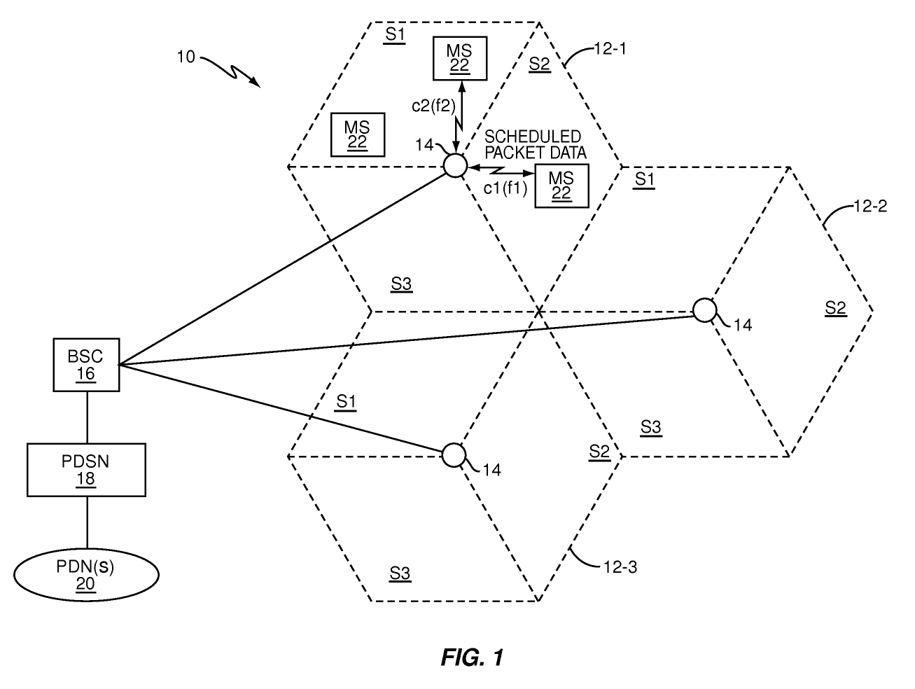

The present invention provides a method and apparatus for facilitating the selection of a carrier frequency for packet and sub-packet data transmissions in a high rate packet data channel. In that context, FIG. 1 partially illustrates an exemplary wireless communication network 10. Network 10 may comprise, for example, a cellular communication network based on the N×EV-DO standards, IS-2000 standards, the W-CDMA standards, or IS-856 standards. As illustrated, network 10 comprises a Radio Access Network (RAN) including Base Transceiver Stations (BTSs) 14 and a Base Station Controller (BSC) 16, and a Packet Data Serving Node (PDSN) 18, which communicatively couples network 10 to one or more Public Data Networks (PDNs) 20, such as the Internet. Those skilled in the art will appreciate that network 10 may include additional entities that are not illustrated for clarity.

Network 10 provides radio coverage organized as a plurality of radio cells 12-1, 12-2, and 12-3, with each cell providing three sectors S1, S2, and S3, of radio coverage. Note that for convenience of discussion, this disclosure focuses on “sectors” as the basic area of radio coverage, but those skilled in the art should appreciate that the same concepts can be applied at varying levels, including for example, at the per-cell level. Mobile stations 22 operating within the network's coverage area generally can receive signals from more than one sector, and the mobile station's return radio signals generally can be received by network 10 at more than one sector.

In one embodiment of network 10, one may assume that the illustrated mobile stations 22 are engaged in high-rate packet data services. The packet data services are provided in a shared, time-allocated manner. More specifically, packet data services are provided over a plurality of shared, time-allocated channels C1, C2 that are accessed at different times by different mobile stations 22. The network 10 shown in FIG. 1 includes two packet data channels C1, C2 in cell 12-1, though additional channels may be provided. Other cells 12-2, 12-3 may provide the same or a different number of packet data channels. Notably, the packet data channels C1, C2 are characterized by unique carrier frequencies f1, f2. In the illustrated example, three mobile stations 22 are engaged in packet data services. However, at any given moment in time, two of the three mobile stations 22 are being served on a unique packet data channel C1, C2 from one of the RBS 14 in network 10. Additional channels may be implemented to instantaneously serve additional mobile stations 22. Each packet data channel C1, C2 may be configured to serve all or a selected group of mobile stations 22 in a given cell 12-1, 12-2, 12-3 or sector S1-S3. Correspondingly, a mobile station 22 within a given cell 12-1, 12-2, 12-3 or sector S1-S3 is able to receive packet data on one or more of the packet data channels C1, C2. Thus, while FIG. 1 shows mobile stations 22 being served by a single packet data channel C1, C2, each mobile station 22 may be served by more than one packet data channel C1, C2.

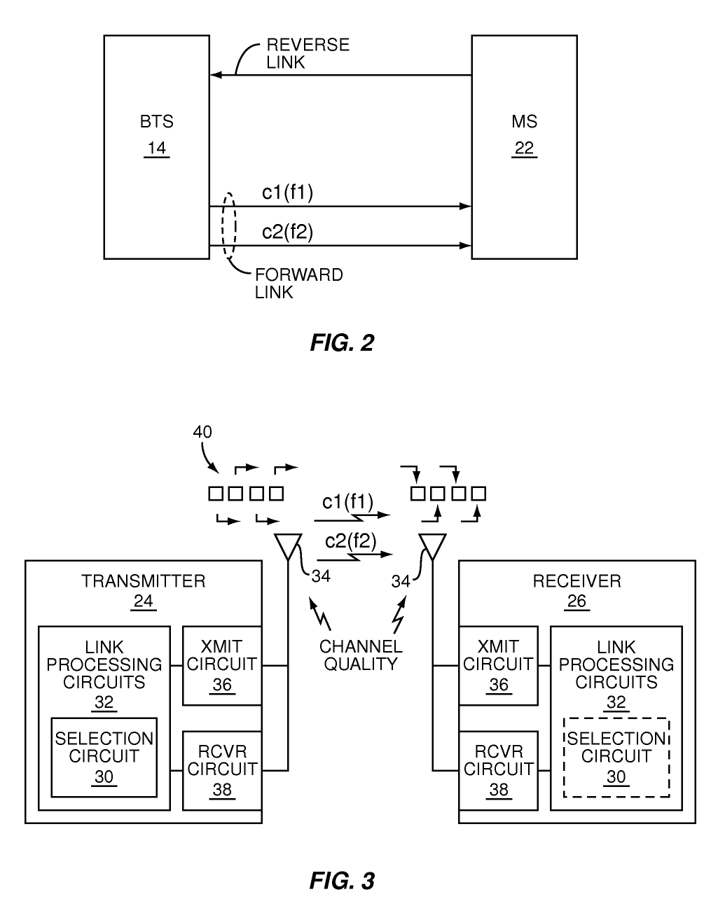

Accordingly, FIG. 2 illustrates a more detailed representation of a high-speed packet data link between a mobile station 22 and a single BTS 14. In the illustrated embodiment, the high-speed packet data link includes a forward link and a reverse link. In other embodiments, the high-speed packet data link may include a forward link or a reverse link only. Furthermore, in the illustrated embodiment, the forward links include multiple channels C1, C2 on which packet data may be transmitted. Each of the channels C1, C2 may include a unique carrier frequency f1, f2 associated with that channel C1, C2. In an unillustrated embodiment, the reverse link may be configured similar to the forward link, comprising multiple channels with unique carrier frequencies.

Packet data may be transmitted from a BTS 14 to a mobile station 22 along a single forward packet data channel C1, C2. In this scenario, the BTS 14 operates as a transmitter and the mobile station 22 as a receiver. Further, since the forward data links include multiple channels C1, C2 with unique carrier frequencies f1, f2, packet data may be transmitted along multiple channels C1, C2 to obtain frequency diversity. FIG. 3 generally illustrates a schematic diagram depicting a generic transmitter 24 and a generic receiver 26 that are in communication with one another via a high speed packet data link characterized by multiple channels C1, C2 with unique carrier frequencies f1, f2.

The transmitter 24 includes associated carrier selection circuitry 30 that determines an extent to which data is transmitted along each of the unique carrier frequencies f1, f2. Optionally, the receiver 26 may include an embodiment of the carrier selection circuitry 30, to support or assist with carrier frequency determinations. The transmitter 24 comprises an antenna assembly 34, which may include separate antennas tuned for a specific carrier frequency or a diversity antenna capable of transmitting and receiving data on multiple frequencies. The transmitter further includes RF receiver and transmitter circuits 36 and 38, respectively, link processing circuit(s) 32, which includes or is associated with the aforementioned carrier selection circuitry 30.

Packet data 40 is transmitted between the respective antennae of the transmitter 24 and receiver 26. In FIG. 3, this packet data 40 is depicted as isolated data blocks, though those skilled in the art will comprehend that packet data 40 may be transmitted as a contiguous string of data. In one or more embodiments, the packet data 40 may be divided for transmission along multiple channels C1, C2, each including a unique carrier frequency f1, f2. In the illustrated embodiment, two channels C1, C2 are shown, but the packet data link may comprise three or more channels. Transmitting packet data along the multiple channels will achieve some amount of frequency diversity. Notably, diverse transmission across multiple channels may require added power and spectrum, but may be appropriate when the packet data link has idle slots available and/or is used by a small number of receivers 26.

The carrier selection circuitry 30 determines the extent to which data is transmitted along each of the unique carrier frequencies f1, f2. That is, the carrier selection circuitry 30 may direct the transmitter 24 to transmit packet data 40 on one or both of the carriers C1, C2. Various factors may be used to determine which of the carriers C1, C2 to use for a given packet data 40 transmission. For instance, one particular carrier C1, C2 may be less congested or noisy than another carrier C1, C2. Consequently, the carrier selection circuitry 30 may divert some or all packet data 40 to improve throughput. Such carrier C1, C2 selections may be implemented in conjunction with known scheduler algorithms including round robin scheduling, proportionally fair scheduling, or maximum throughput scheduling. Further, carrier C1, C2 selection may be determined at either the transmitter 24 or receiver 26.

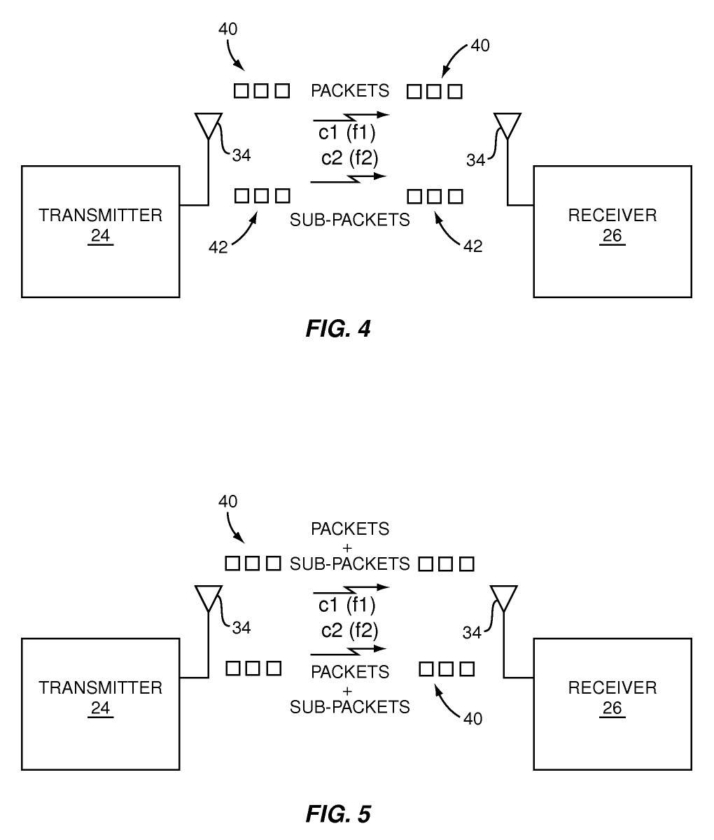

FIG. 4 illustrates an exemplary data transmission in which packet data 40 is divided among two channels C1, C2 operating at unique carrier frequencies f1, f2. In this particular implementation, packet data is transmitted from the transmitter 24 to the receiver 26 along a first channel C1 at a first carrier frequency f1. FIG. 4 further suggests that sub-packets transmitted as part of an ARQ or HARQ protocol may be transmitted along a different channel C2 at a second carrier frequency f2. Certainly, it may be the case that re-transmission sub-packets are transmitted along the same channel C1 as were the original, erroneously received packets. In fact, the retransmission data may be transmitted diversely along a plurality of channels C1, C2. However, in the illustrated embodiment, if the receiver 26 detects a transmission error for a packet of data received on the first channel C1, the receiver 26 may transmit a negative acknowledgement (NAK) to the transmitter 24 requesting re-transmission of the packet or sub-packet data in accordance with the ARQ/HARQ protocol for reconstruction of the erroneous packet. Pursuant to receiving the NAK from the receiver 26, the transmitter 24 re-transmits the entire packet or suitable sub-packet data on the second channel C2. The packet retransmissions may comprise entire packets 40 or sub-packet data as is known in the art. Executing the re-transmissions in this manner may improve packet data link capacity by transmitting the packet data in fewer slots than the nominal span required for transmission along a single carrier frequency.

FIG. 5 illustrates an alternative implementation to obtain frequency diversity. In this particular data transmission, packet data 40 is divided among two carriers C1, C2 operating at unique carrier frequencies f1, f2. The packet data 40 is not necessarily divided equally among the carriers C1, C2. More of the packet data 40 may be transmitted on one or the other carrier C1, C2. In certain situations, all of the packet data 40 may be transmitted on one of the carriers C1, C2 but not the other. FIG. 5 further suggests that retransmitted data, such as packets or sub-packets transmitted as part of an ARQ or HARQ protocol may be transmitted along each of the carriers C1, C2. In one embodiment similar to FIG. 4, the retransmitted data is transmitted along a different channel C1, C2 than the original, erroneously received packets. In one embodiment, the retransmitted data is transmitted along the same channel as the erroneously received packets.

Further, those skilled in the art should appreciate that the illustrated circuits shown in FIGS. 2-5 may comprise hardware, software, or any combination thereof. For example, the carrier selection circuit 30 and link processing circuits 32 may be separate hardware circuits, or may be included as part of other processing hardware. More advantageously, however, the carrier selection circuit 30 and link processing circuits 32 are at least partially implemented via stored program instructions for execution by one or more microprocessors, Digital Signal Processors (DSPs), Application Specific Integrated Circuits (ASICs) or other digital processing circuit included in the transmitter 24 and/or receiver 26.

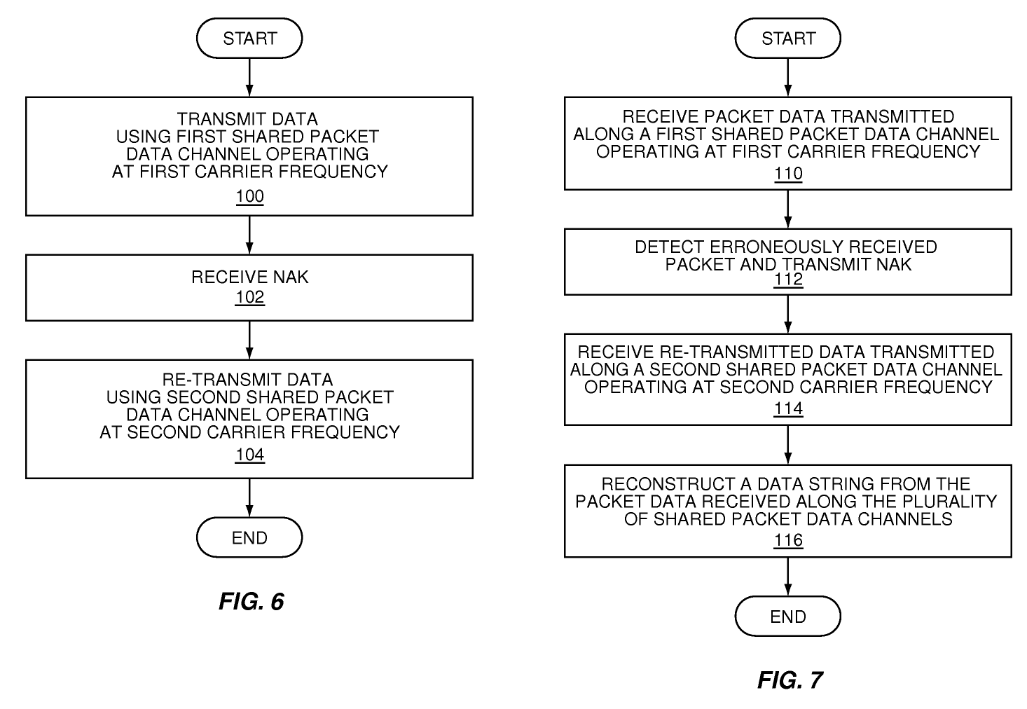

FIG. 6 broadly illustrates exemplary processing performed by the carrier selection circuit 30 and link processing circuit 32 of a representative transmitter 24. More particularly, FIG. 6 illustrates packet data and retransmission data processing performed by the carrier selection circuit 30 and link processing circuit 32. According to the illustrated processing logic, the carrier selection circuit 30 and link processing circuit 32 select a given carrier to transmit packet data. Assuming one or more packets are dropped or erroneously received, the link processing circuit 32 receives a NAK indicative of an erroneous packet received by the receiver 26. Pursuant to the received NAK, the carrier selection circuit 30 identifies a second carrier frequency to be used by the link processing circuit 32 in delivering retransmission packets or sub-packets. Then, the link processing circuit 32 in the transmitter 24 transmits the retransmission data along the selected second carrier frequency.

FIG. 7 broadly illustrates exemplary processing performed by the link processing circuit 32 and optional carrier selection circuit 30 of a representative receiver 26. More particularly, FIG. 7 illustrates packet data and retransmission data processing performed by the receiver 26 in conjunction with the receiver 24 processing shown in FIG. 6. In short, the receiver 26 must be able to receive and reconstruct the packet data transmitted by the receiver 24. According to the illustrated processing logic, the link processing circuit 32 receives the packet data transmitted along a first of multiple channels characterized by different carrier frequencies. Upon detecting an erroneously received packet on the first channel, the link processing circuit 32 transmits a NAK to the transmitter 24 requesting retransmission of packet or sub-packet data. Next, the link processing circuit 32 in the receiver 26 receives the retransmission data from a second of the multiple channels. Then, the link processing circuit 32 in the receiver 26 reconstructs the data string from the packet data and retransmission data received from the plurality of channels. Note that the second channel used for retransmission data may be selected by a carrier selection circuit 30 in either the transmitter 24 or the receiver 26.

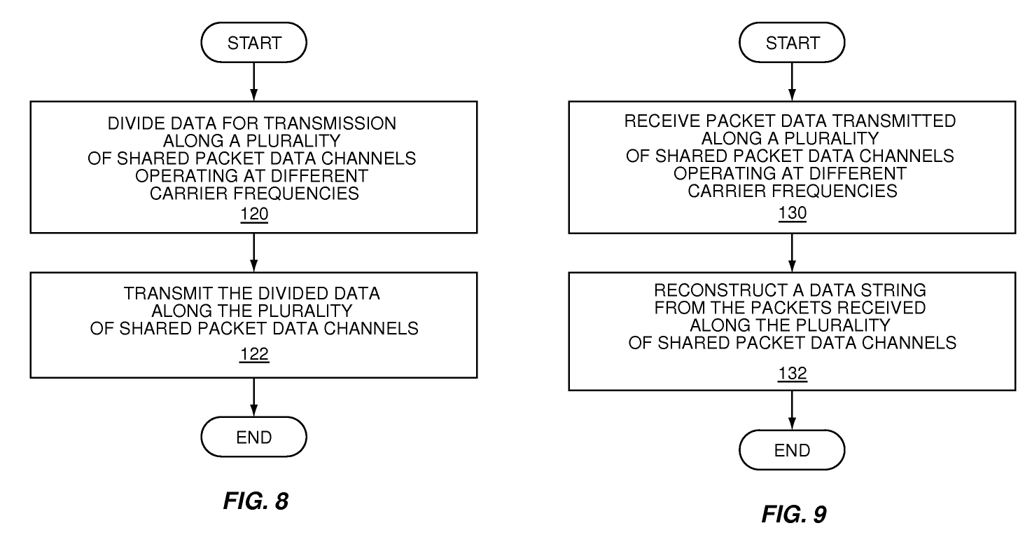

FIG. 8 broadly illustrates exemplary processing performed by the carrier selection circuit 30 and link processing circuit 32 of a transmitter 24. In this particular case, the illustrated logic describes steps performed to achieve diversity transmission of packet data along multiple channels operating at different carrier frequencies. The carrier selection circuit 30 divides the packet data 40 for transmission along a plurality of carrier frequencies. The packet data 40 may be distributed equally among the plurality of channels. Alternatively, the packet data 40 may be distributed in different ratios as determined by the carrier selection circuit 30 based on such factors as congestion, noise, or predetermined settings. Then, the transmitter 24, via associated link processing circuit 32 and transmit/receive circuits 36, 38 transmits the packet data 40 along the plurality of carrier frequencies. In the illustrated processing logic, it is presumed that re-transmission of erroneous packets and/or sub-packet data is divided according to the ratio determined by the carrier selection circuit. That is, packet or sub-packet retransmissions are delivered along the same carrier frequency as the original erroneous packet. However, in an alternative approach, packet or sub-packet retransmissions are delivered along a different carrier frequency as the original erroneous packet.

FIG. 9 broadly illustrates exemplary processing steps performed by the link processing circuit 32 of a receiver 26. The above descriptions have illustrated a variety of techniques for achieving frequency diversity in transmitting packet data. As a corollary to dividing the data for transmission along multiple carrier frequencies, the receiver 26 must be able to receive and reconstruct the divided packet data. According to the illustrated processing logic, the link processing circuit 32 receives the packet data transmitted along the plurality of carrier frequencies. The divided packet data may be coded to identify the carrier from which the data is received and further to define the location for the packet data in a data string. Notably, a wireless communication protocol that enables multiple carrier frequencies includes receivers that are able to decode multiple carriers. Therefore, minimal complexity is required to decode packets and/or sub-packets of a common data string that are transmitted along different carriers.

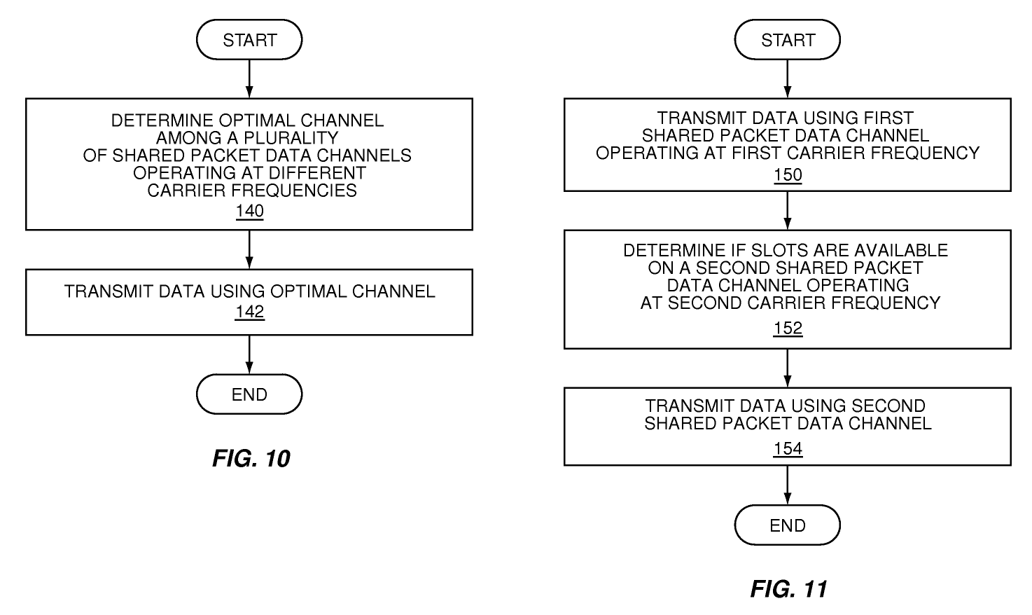

In various embodiments described herein, the carrier selection circuit 30 selects a given channel with a unique carrier frequency for transmitting packet data and retransmission data. In certain implementations, packet data is transmitted on a first channel while retransmission data is transmitted on a second channel. In other implementations, packet data is transmitted in a diverse manner across multiple channels in equal or unequal proportions. In other implementations, different data is transmitted across multiple channels in equal or unequal proportions. Other embodiments may implement a combination of these transmission schemes. Regardless of the transmission scheme, the channels selected for transmitting data may be determined using the exemplary processing steps illustrated in FIG. 10. The extent to which packet data or retransmission data is divided and transmitted along the different carrier frequencies may be based in part on determining an optimal carrier frequency. The term “optimal” may have different meanings depending on a particular implementation. In one aspect, optimal may mean capable of achieving a greater throughput. In another aspect, optimal may mean capable of achieving a cleaner throughput with fewer retransmissions. These goals may be dependent upon channel conditions, which may be provided by the transmitter 24 or the receiver 26. Further, carrier selection may be executed by carrier selection circuitry 30 at either the transmitter 24 or the receiver 26. In another aspect, optimal may mean conforming to a predetermined setting. In any event, the carrier selection circuit 30 determines the optimal carrier frequency and accordingly divides the packet data for transmission using the optimal carrier frequency. This exemplary processing logic may result in all or a majority of packet data being transmitted along the optimal carrier frequency.

In various embodiments described herein, the carrier selection circuit 30 may select whether to transmit packet data or retransmission data over a plurality of channels based partly on channel congestion. FIG. 11 illustrates exemplary processing steps to determine whether packet data or retransmission data is delivered on a second shared packet data channel. It is generally assumed that a transmitter will transmit data using a first shared packet data channel operating at first carrier frequency as in conventional systems. Where multiple shared packet data channels are available, the transmitter may determine if slots are available on a second shared packet data channel operating at second carrier frequency. This may be the case if the number of users requesting shared packet data service is small. If transmission slots are available on the second shared packet data channel, the transmitter may transmit data using the second shared packet data channel. This transmission via the second shared packet data channel may comprise diverse packet data, implying that a data string is split into packets and transmitted simultaneously via the plurality of channels. Further, the transmission via the second shared packet data channel may comprise wholly different packet data unrelated to the packet data transmitted on the first shared packet data channel.

The present invention, as illustrated by the above exemplary embodiments, comprises a method and apparatus facilitating the selection between multiple carrier frequencies for packet and sub-packet data transmissions in a high rate packet data channel. Frequency diversity may be achieved through simultaneously transmitting packet data on multiple carrier frequencies. As suggested herein, selection of which, and to what extent, carriers are used to transmit packet data or data retransmissions may be incorporated at either the receiver or transmitter level. The transmitter may be a mobile station or BTS. Conceivably, carrier selection may be executed at a BSC or other level upstream of the communications link between a BTS and mobile station. It should be understood, then, that the present invention is not limited by the foregoing discussion, but rather by the following claims and their legal equivalents.

What is claimed is:

1. A method of transmitting packet data to a mobile station in a wireless communication network with scheduled packet data service comprising:
transmitting scheduled packet data to the mobile station via a first shared packet data channel operating at a first carrier frequency;
receiving a negative acknowledgement indicative of erroneous packet data reception by the mobile station; and
transmitting scheduled retransmission data to the mobile station in response to the negative acknowledgement via a second shared packet data channel operating at a second carrier frequency different from the first carrier frequency.

2. The method of claim 1 wherein the first and second shared packet data channels conform to an N×EV-DO wireless communications protocol.

3. The method of claim 1 wherein the negative acknowledgement and retransmission data conform to an HARQ error control scheme.

4. The method of claim 1 wherein the step of transmitting scheduled retransmission data to the mobile station in response to the negative acknowledgement via the second shared packet data channel further comprises transmitting substantially all retransmission data on the second shared packet data channel.

5. The method of claim 1 wherein the step of transmitting scheduled retransmission data to the mobile station in response to the negative acknowledgement via the second shared packet data channel further comprises transmitting a portion of the retransmission data on the first shared packet data channel.

6. The method of claim 1 further comprising transmitting scheduled packet data to the mobile station via the second shared packet data channel.

7. The method of claim 1 further comprising determining an optimal channel among a plurality of shared packet data channels operating at different carrier frequencies and transmitting packet data via the optimal channel.

8. The method of claim 1 further comprising determining an optimal channel among a plurality of shared packet data channels operating at different carrier frequencies and transmitting retransmission data via the optimal channel.

9. The method of claim 1 further comprising determining that transmission slots are available on the second shared packet data channel and transmitting packet data via the second shared packet data channel.

10. The method of claim 9 wherein transmitting packet data via the second shared packet data channel further comprises diversely transmitting packet data via the first and second shared packet data channels.

11. The method of claim 9 wherein transmitting packet data via the second shared packet data channel further comprises transmitting different packet data via the first and second shared packet data channels.

12. The method of claim 1, wherein the first and second shared packet data channels conform to a multi-carrier wireless communication protocol employing an HARQ error control scheme.

13. At a mobile station, a method of receiving packet data in a wireless communication network with scheduled packet data service comprising:
receiving scheduled packet data via a first shared packet data channel operating at a first carrier frequency;
detecting an erroneously received packet from the first shared packet data channel;
transmitting a negative acknowledgement in response to detecting the erroneously received packet; and
receiving scheduled retransmission data corresponding to the erroneously received packet via a second shared packet data channel operating at a second carrier frequency different from the first carrier frequency.

14. The method of claim 13 wherein the first and second shared packet data channels conform to an N×EV-DO wireless communications protocol.

15. The method of claim 13 wherein the negative acknowledgement and retransmission data conform to an HARQ error control scheme.

16. The method of claim 13 wherein the step of receiving scheduled retransmission data corresponding to the erroneously received packet via a second shared packet data channel further comprises receiving substantially all retransmission data on the second shared packet data channel.

17. The method of claim 13 wherein the step of receiving scheduled retransmission data corresponding to the erroneously received packet via a second shared packet data channel further comprises receiving a portion of the retransmission data on the first shared packet data channel.

18. The method of claim 13 further comprising receiving scheduled packet data via the second shared packet data channel.

19. The method of claim 13 further comprising determining an optimal channel among a plurality of shared packet data channels operating at different carrier frequencies and receiving packet data via the optimal channel.

20. The method of claim 13 further comprising determining an optimal channel among a plurality of shared packet data channels operating at different carrier frequencies and receiving retransmission data via the optimal channel.

21. The method of claim 13 further comprising determining that transmission slots are available on the second shared packet data channel and receiving packet data via the second shared packet data channel.

22. The method of claim 21 wherein receiving packet data via the second shared packet data channel further comprises diversely receiving packet data via the first and second shared packet data channels.

23. The method of claim 21 wherein receiving packet data via the second shared packet data channel further comprises receiving different packet data via the first and second shared packet data channels.

24. The method of claim 13, wherein the first and second shared packet data channels conform to a multi-carrier wireless communication protocol employing an HARQ error control scheme.

25. A radio base station system comprising:
one or more channel processing circuits configured to transmit scheduled packet data to a mobile station via a first shared packet data channel operating at a first carrier frequency, and upon receiving a negative acknowledgement indicative of erroneous packet data reception by the mobile station, transmitting scheduled retransmission data to the mobile station in response to the negative acknowledgement via a second shared packet data channel operating at a second carrier frequency different from the first carrier frequency; and
one or more transceiver circuits configured to transmit the packet data and retransmission data.

26. The radio base station of claim 25 wherein the first and second shared packet data channels conform to an N×EV-DO wireless communications protocol.

27. The radio base station of claim 25 wherein the negative acknowledgement and retransmission data conform to an HARQ error control scheme.

28. A mobile station comprising:
radio frequency transceiver circuits configured to send signals to and to receive signals from a wireless communication network; and
one or more channel processing circuits operatively associated with the radio frequency transceiver circuits and configured to reconstruct a data string upon receiving scheduled packet data via a first shared packet data channel operating at a first carrier frequency, detecting an erroneously received packet from the first shared packet data channel, transmitting a negative acknowledgement in response to detecting the erroneously received packet, and receiving scheduled retransmission data corresponding to the erroneously received packet via a second shared packet data channel operating at a second carrier frequency different from the first carrier frequency.

29. The mobile station of claim 28 wherein the first and second shared packet data channels conform to an N×EV-DO wireless communications protocol.

30. The mobile station of claim 28 wherein the negative acknowledgement and retransmission data conform to an HARQ error control scheme.

31. The mobile station of claim 28, wherein the first and second shared packet data channels conform to a multi-carrier wireless communication protocol that employs an HARQ error control scheme.

32. A method of transmitting packet data to a mobile station in a wireless communication network for packet data service comprising:
transmitting scheduled first packet data to the mobile station via a first shared packet data channel operating at a first carrier frequency;
while transmitting the first packet data, determining that transmission slots are available via a second shared packet data channel operating at a second carrier frequency different from the first carrier frequency; and
transmitting scheduled second packet data to the mobile station via the second shared packet data channel.

33. The method of claim 32 wherein transmitting the first and second packet data comprises diversely transmitting of the same packet data over the first and second shared packet data channels.

34. The method of claim 32 wherein transmitting the first and second packet data comprises transmitting different packet data over the first and second shared packet data channels.

35. The method of claim 32 wherein the second packet data comprises retransmission data.

36. The method of claim 35 wherein the retransmission data conforms to an HARQ error control scheme.

37. The method of claim 32 wherein the first and second shared packet data channels conform to an N×EV-DO wireless communications protocol.

38. The method of claim 32, wherein the first and second shared packet data channels conform to a multi-carrier wireless communication protocol employing an HARQ error control scheme.
